(19) United States
(12) Patent Application Publication
(10) Pub. No.: US 2009/0241033 A1
(43) Pub. Date: Sep. 24, 2009

(54) PARTICIPANT RESPONSE AND POLLING SYSTEM

(75) Inventor: Mustafa MUJTABA, Fort Myers, FL (US)

Correspondence Address: HAHN LOESER & PARKS, LLP, One GOJO Plaza, Suite 300, AKRON, OH, 44311-1076, US

(73) Assignee: FLORIDA GULF COAST UNIVERSITY, Fort Myers, FL (US)

(21) Appl. No.: 12/408,943

(22) Filed: Mar. 23, 2009

Related U.S. Application Data
(60) Provisional application No. 61/038,486, filed on Mar. 21, 2008.

(51) Int. Cl. G06F 3/048

(52) U.S. Cl. 715/752

(57) ABSTRACT

A system and methods for polling a group and automatically gathering and analyzing responses from the group. The system and methods provide an interactive web-based service that allows participants (e.g., students, meeting attendees, conference attendees) to interact with a user (e.g., a teacher, an instructor, a presenter, a lecturer) via a cell phone or other device in order to efficiently and effectively provide feedback to the user. Such feedback enables the user to modify or clarify his/her presentation or instruction in real time to address any misunderstandings of the participants.

### CROSS-REFERENCE TO RELATED APPLICATIONS

This application claims the benefit of U.S. provisional patent application 61/038,486 filed Mar. 21, 2008, which is hereby incorporated by reference.

### TECHNICAL FIELD

Certain embodiments of the present invention relate to polling and responding. More particularly, certain embodiments of the present invention relate to systems and methods for polling a group of participants and automatically gathering and analyzing responses from the participants in real time using web-based technologies and methodologies.

### BACKGROUND

Obtaining feedback from a group of participants (e.g., a group of students in a classroom), in order to help determine a level of understanding of the group and the individuals in the group, is typically not accomplished until a formal exam or quiz is administered. Being able to obtain feedback in real time during the course of a presentation or lecture may prove to be a valuable capability that allows the presenter or instructor to dynamically adjust a presentation or lecture in real time to address any misunderstandings of the group participants.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY

An embodiment of a polling and responding system comprises a cell phone response system that includes an interactive web-based software program that allows participants in the classroom, lecture hall, meetings, and conferences to interact with the teacher, instructor, or presenter, for example. Participants may use their cell phones to text message to a specific e-mail address the responses to questions presented by the lead instructor.

Based on tabulated response evaluations, the instructor may gear the lecture for enhancing student (participant) understanding of the concepts being reviewed. Responding is not restricted to using a cell phone, however. Participants may use other devices, which may send e-mail, for submitting their responses. Such other devices may include, for example, a lap top computer, a desk top computer, a web-enabled personal digital assistant (PDA), a smart phone, or some other such device.

The system may further be used for online classes and meetings. In such cases where the participants are at different locations geographically around the world, but are meeting at the same time, each participant may still view group results via the web.

Questions asked during a live session may be asked “on the fly” and responses processed. However, the presenter may have the option of uploading questions to the system prior to start of their presentation. The program automatically advances through the questions each time the presenter “clicks” to go to the next question.

Responses to the questions may be tabulated and graphed. The presenter has several options in terms of presenting the evaluated response results. The program contains both graphic and tabular formats for result presentation. There are several table forms to choose from to present the evaluated responses. The presenter has the option of presenting the group responses anonymously as well.

Furthermore, responses and percent scores from participants that register their cell identification (ID) may be summarized and saved for later evaluation. Group percent scores may also be summarized and saved. Data may be exported (downloaded) to a spreadsheet program for detailed evaluations, for example.

These and other advantages and novel features of the present invention, as well as details of illustrated embodiments thereof, will be more fully understood from the following description and drawings.

### BRIEF DESCRIPTION OF THE DRAWINGS

FIG. 1 illustrates a functional flow diagram of exemplary embodiments of methods used in an embodiment of a participant response and polling system;

FIGS. 2A-2B illustrate an exemplary embodiment of a screen shot of a login page of a predefined web site of the CPR system;

FIG. 3 illustrates an exemplary embodiment of a screen shot of the graph mode of the CPR system;

FIG. 4 illustrates an exemplary embodiment of a screen shot of the CPR system used for assigning a cell ID;

FIGS. 5A-5B illustrate an exemplary embodiment of a screen shot of a questions page of the CPR system;

FIG. 6 illustrates an exemplary embodiment of a screen shot associated with a viewing area of the CPR system;

FIGS. 7A-7B illustrate an exemplary embodiment of a screen shot of the CPR system used for submitting an answer to a question;

FIG. 8 illustrates an exemplary embodiment of a screen shot of a results table of the CPR system obtained by clicking on the “Results/Table” button;

FIG. 9 illustrates an exemplary embodiment of a screen shot of a individual response table of the CPR system with participant names included;

FIG. 10 illustrates an exemplary embodiment of a screen shot of a individual response table of the CPR system without participant names included;

FIG. 11 illustrates an exemplary embodiment of a screen shot associated with clearing submitted participant responses for a particular question;

FIGS. 12A-12B illustrate an exemplary embodiment of a screen shot associated with a summary of participant results; and

FIG. 13 illustrates an exemplary embodiment of a screen shot associated with logging out of the CPR system.

### DETAILED DESCRIPTION

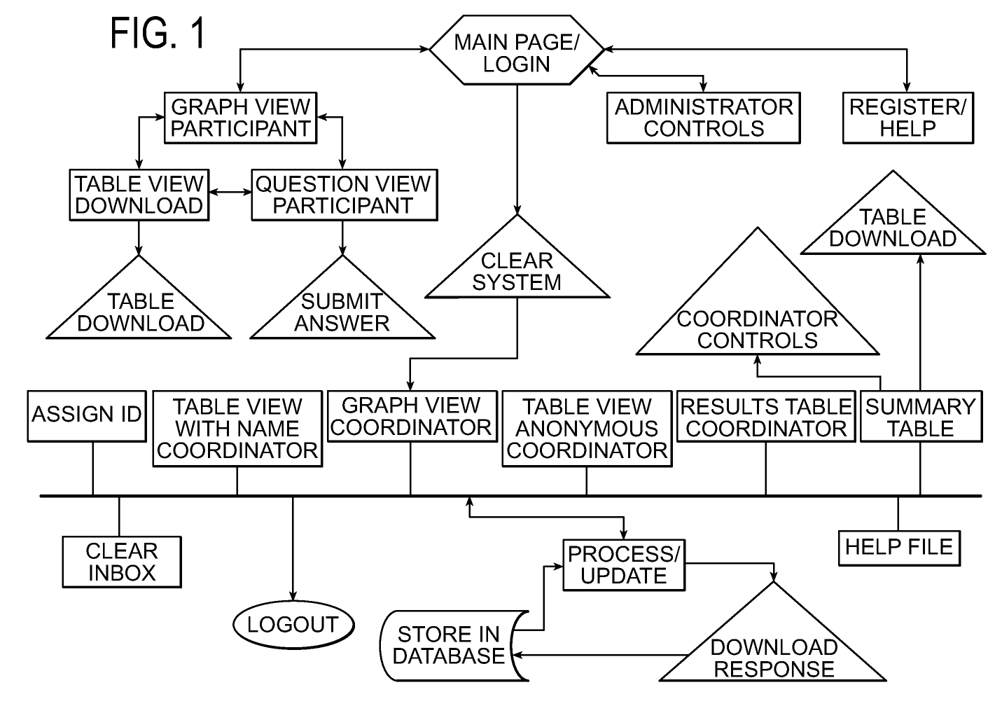

An embodiment of a cell phone response (CPR) system comprises a web-based system that may be accessed at any time and anywhere in the world where there is an internet connection available. Alternatively to the use of cell phones, other wired or wireless devices that have internet connectivity may be used to access and use the system. The web-based system may reside on a web server, in accordance with an embodiment, and does not require the user to download or otherwise integrate the program into the device used to access the system. The system and methods also use one-way communication from the cell phone or other devices, providing a simple and cost-effective system for allowing participation and response by users. FIG. 1 illustrates a functional flow diagram of exemplary embodiments of methods used in an embodiment of a participant response and polling system (e.g., a CPR system). The example system is generally shown at 10, in association with a main page/login 12, for use with an example where access and communication is performed via the Internet by means of cell phones and other web-based devices. Other examples may allow communication on a dedicated server and wireless access system if desired, or other suitable systems. As shown in this example, the Main Page/Login 12 is in communication with further pages or sites, including a Graph View Participant page 14, Administrator Controls 16 and Register/Help 18. The Graph View Participant 14 further links to a Table View Participant page 20 and Question View Participant page 22 for example. Further, the Table View Participant 20 may link to a Table Download 24, and the Question View Participant 22 links to a Submit Answer 26. The Main Page 12 may also be linked to a Clear System 28. The Clear System 28 communicates with a series of functions or pages such as an Assign ID 30, Table View with Name Coordinator 32, Graph View Coordinator 34, Table View Anonymous Coordinator 36, Results Table Coordinator 38 and Summary Table 40. The Summary Table in turn connects to Coordinator Controls 42 and Table Download 44. There may also be access to a Clear Inbox 46 and Help File 48. The system 10 may use Process/Update 50 functions to process responses from participants and perform other processing if necessary, and provide Store In Database 52 and Download Response 54 functions to communicate response or other information. A Logout 56 allows participants to exit the system. These and other functions are further described below.

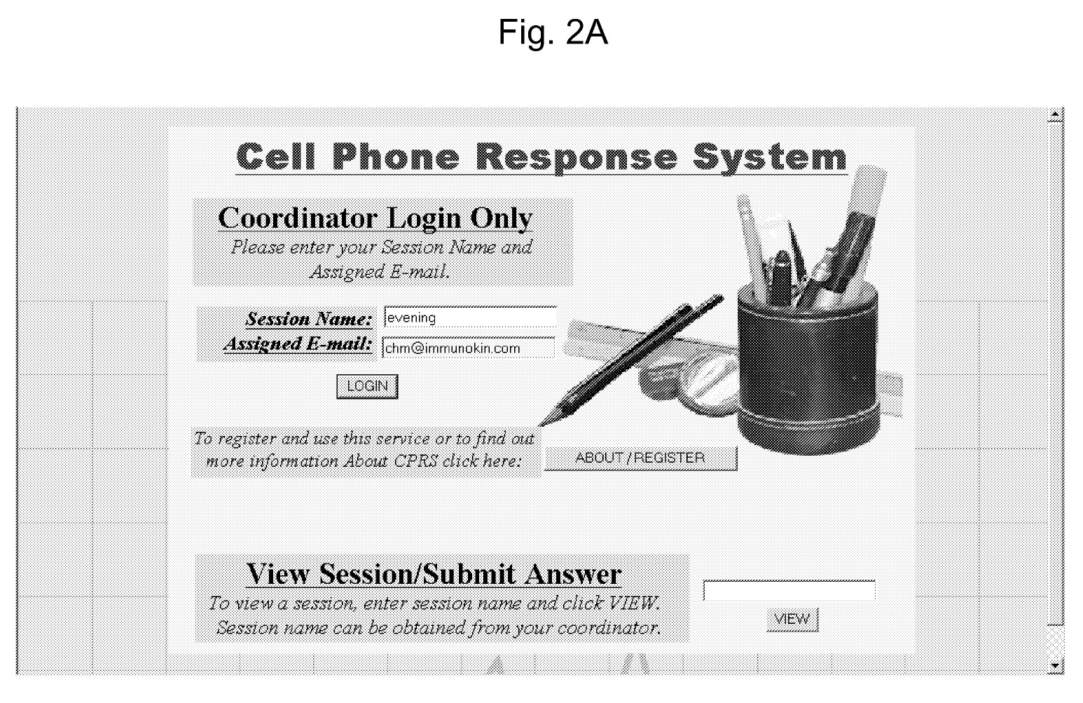

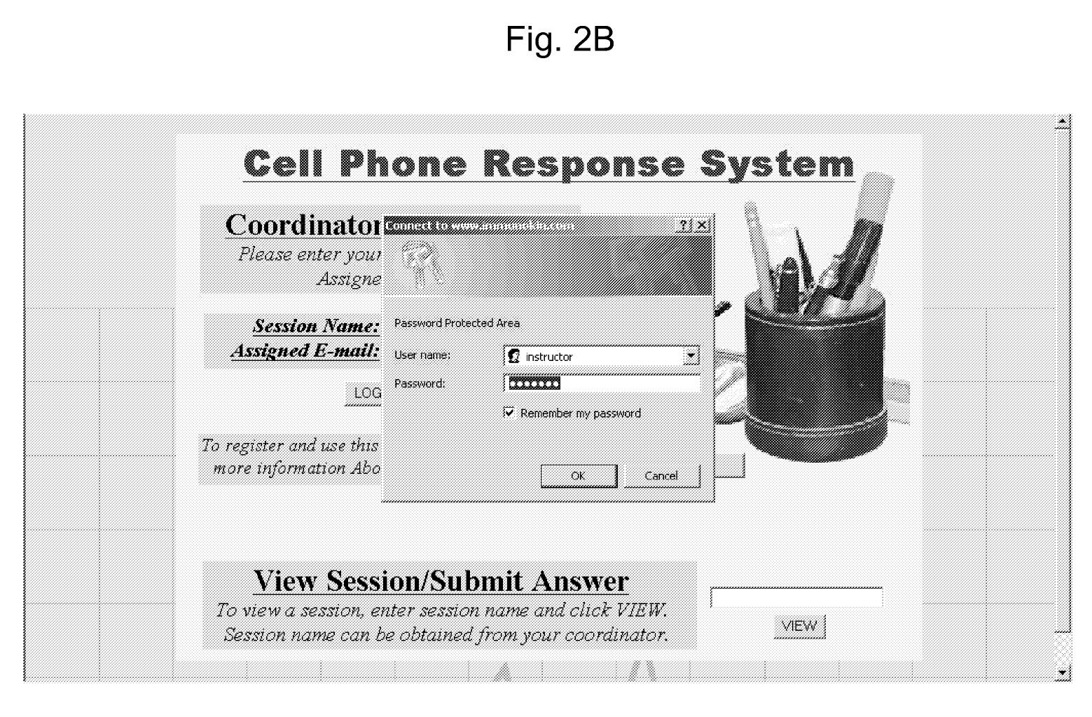

An embodiment of a CPR system allows for a user to register and activate an account. Prior to registering and activating an account, however, it may be desirable to determine the class size which constitutes the total number of participants that may submit responses via, for example, cell phones and other web-based devices for this account. FIGS. 2A-2B illustrate an exemplary embodiment of a screen shot of a login page of a predefined web site of the CPR system. Once class size is determined, the user may proceed to the predefined web site (e.g., as illustrated in FIG. 2A). The user clicks on the “About/Register” button and supplies the necessary information and submits the registration form for account activation. After the registration form is submitted, the user receives an e-mail containing a session name, an assigned e-mail address, a user name, and a user password. This information may be used to login at the assigned e-mail address (see FIG. 2B), since reception of the e-mail indicates that the account is activated. For setting up the system, a class or meeting coordinator may set up an account via the web-based system to which can then log in to in this manner, or an educational or other institution may acquire a facility or site license for allowing subsequent access by users.

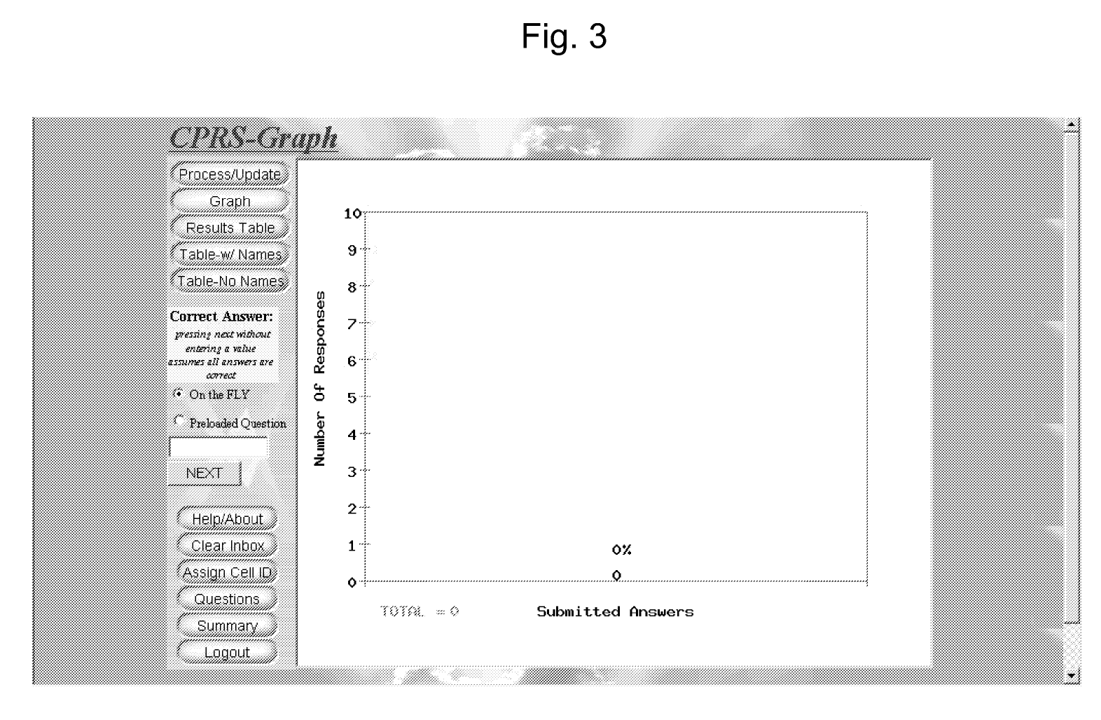

A user may log in by entering the session name and assigned e-mail address, as shown in FIG. 2A, and clicking “LOGIN”. The user is then prompted to enter a username and password as shown in FIG. 2B. Once logged in, the user may be directed to the graph mode of the CPR system. FIG. 3 illustrates an exemplary embodiment of a screen shot of the graph mode of the CPR system.

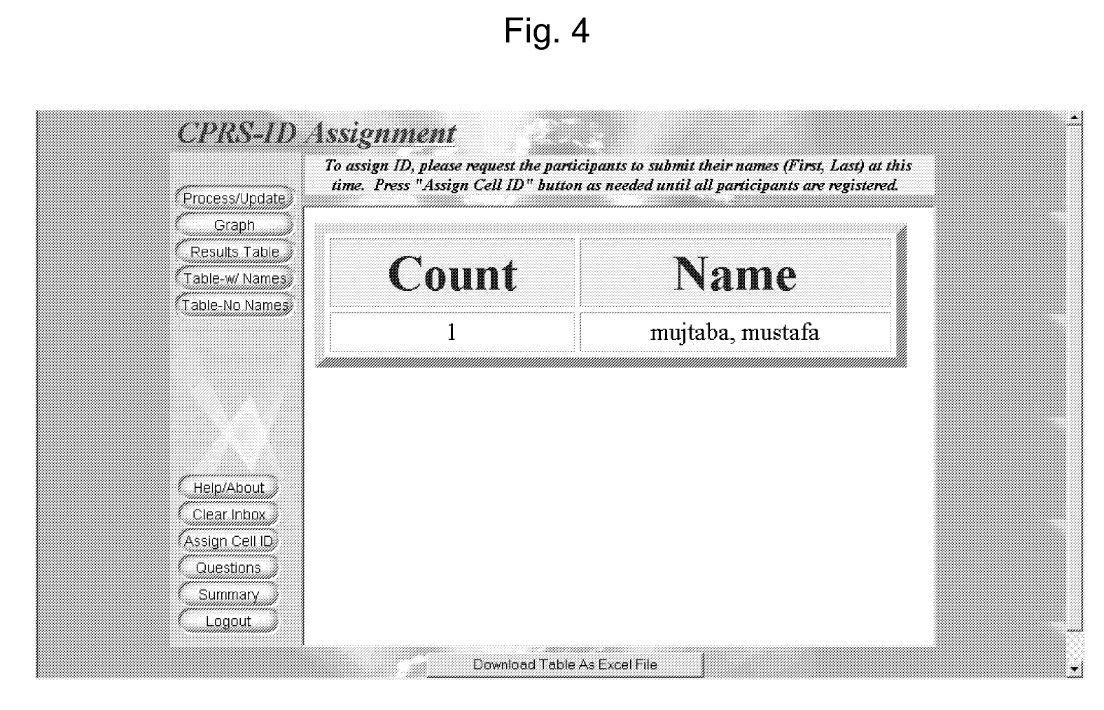

If a user desires to save results, the user is directed to assign a cell identifier (ID) to each participant. This may allow testing or grading of answers to be performed, as each respondent will have a unique identifier. The system uses each participant's cell phone number or e-mail address as their unique ID. FIG. 4 illustrates an exemplary embodiment of a screen shot of the CPR system used for assigning a cell ID. To assign a cell ID, the user clicks on the “Assign Cell ID” button (see FIG. 3). Each participant is asked to text message their name to the assigned e-mail address provided during account activation (see FIG. 4). For example, name submissions, whether through a cell phone or other devices, may be enclosed in asterisks such as, for example, *John Smith*. The “Assign Cell ID” button is clicked on by the user until all participants have been registered in this manner. Assigning cell ID is not necessary if you do not want to save the result. However, if it is desired to save all results, the participants should be assigned an ID. The system may use each participant's cell phone number or e-mail address as the unique ID, or other suitable ID may be used.

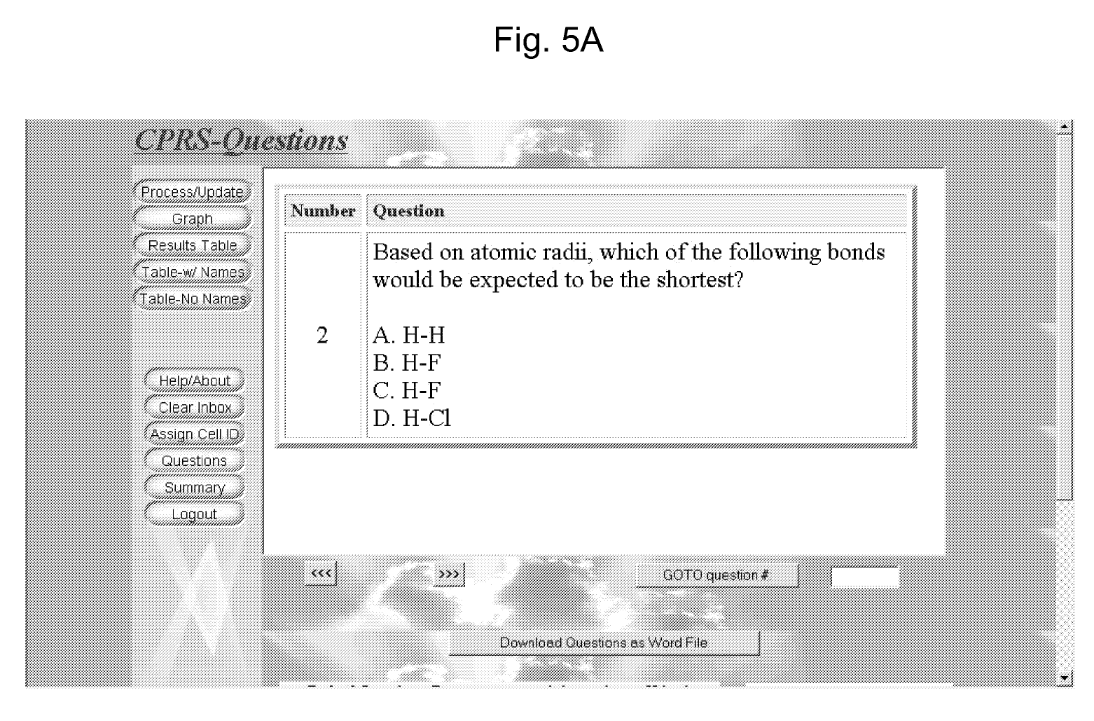

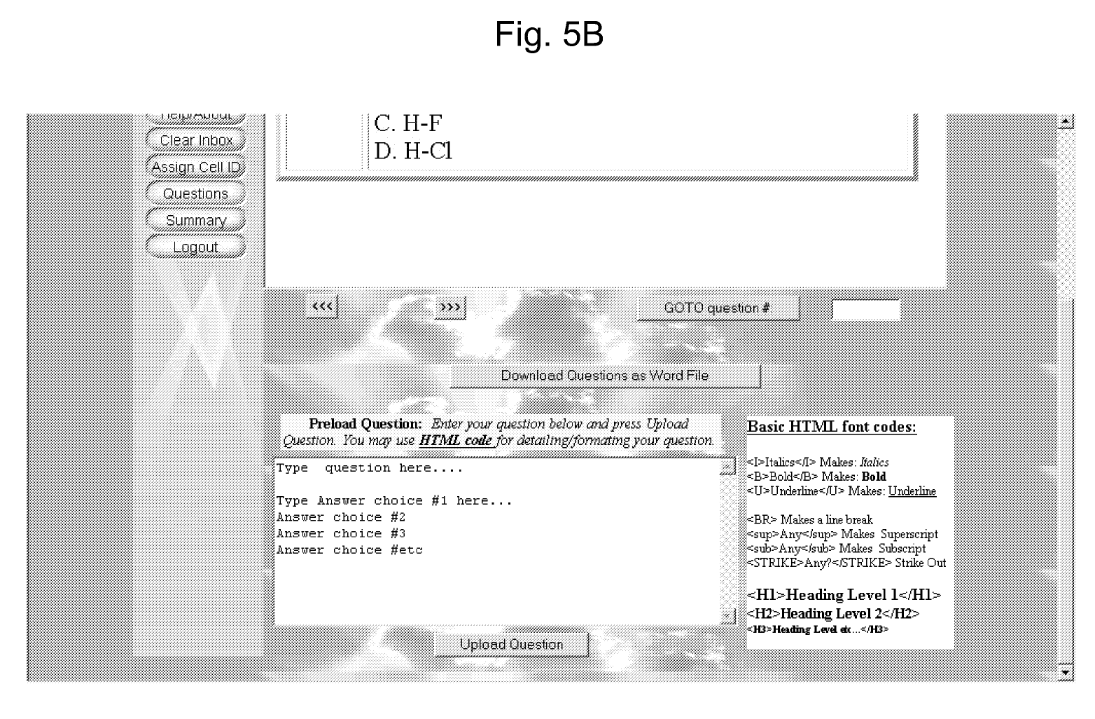

When using the CPR system, questions may be asked as the presentation (class) proceeds “on the fly”, or the questions may be uploaded ahead of time. For example, referring to FIG. 3, the user may click on the “Questions” button. FIGS. 5A-5B illustrate an exemplary embodiment of a screen shot of a questions page of the CPR system. At the bottom of FIG. 5B is an area to input the questions, one-by-one, for uploading. The user may use HTML script to format each question. Each uploaded question may then be viewed by selecting the left or right arrow buttons or by entering the question number (see FIG. 5A).

In accordance with an embodiment, participants may use their cell phones to text message, to a specific e-mail address assigned to the session, the responses to the questions presented. The method of responding is not restricted to using a cell phone, however. Participants may also use, if available, other devices which are capable of sending e-mail for submitting responses including lap top and desk top computers, web-enabled PDA's, smart phones, and other devices.

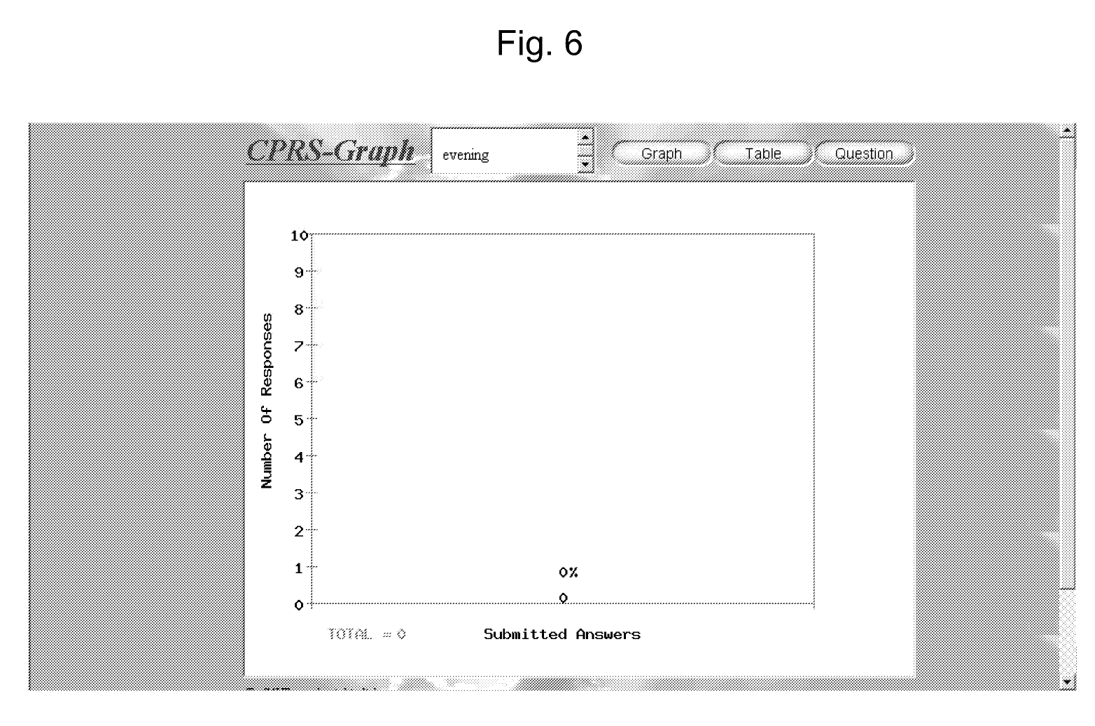

Furthermore, the web-based program of the CPR system includes a website where participants may submit their responses if a participant has a web-browser enabled device. To access the system's submitting site, participants may simply point their web browser to the main page of the system website (e.g., see FIG. 2A). At the bottom of the main page is an area called “View Session/Submit Answer”. Participants that wish to use the website to submit their answers may enter the session name and click the “VIEW” button. The web browser is then routed to the “viewing” area, as shown in FIG. 6, where a participant may click the “question” button to view and answer the current question.

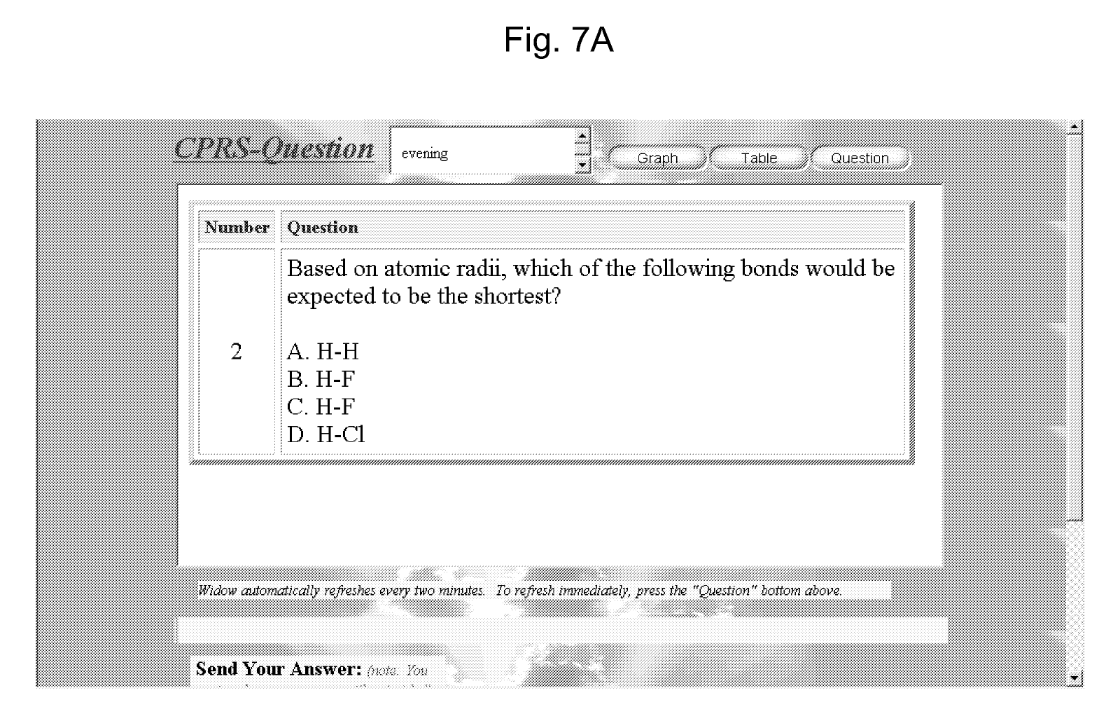

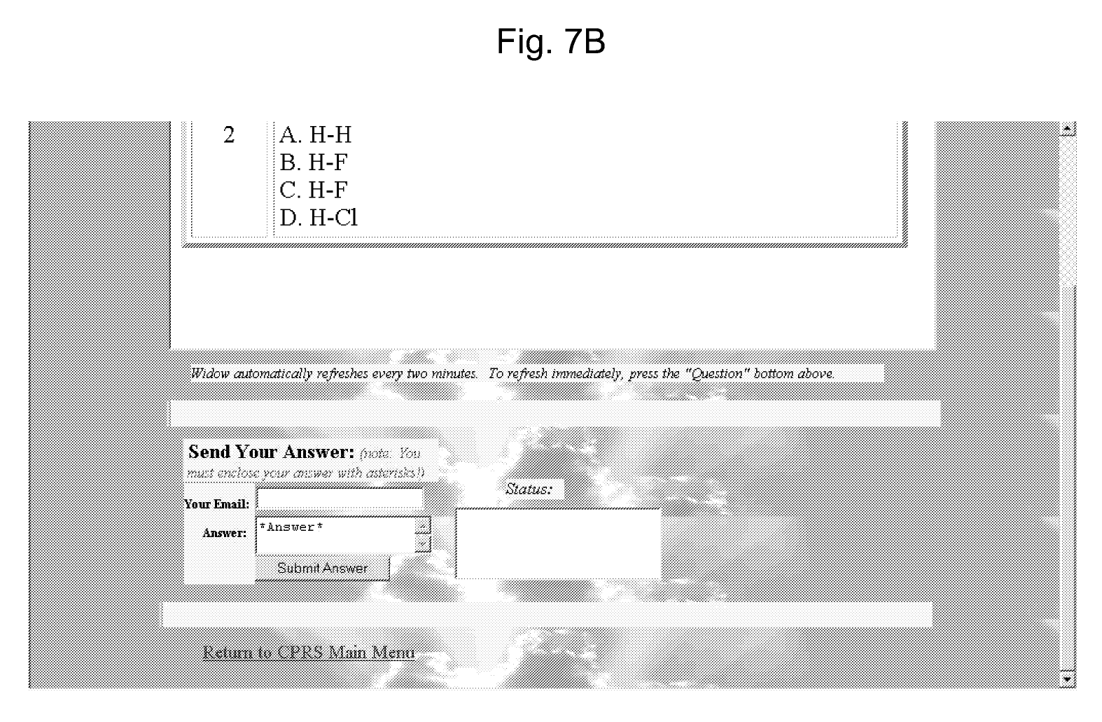

FIGS. 7A-7B illustrate an exemplary embodiment of a screen shot of the CPR system used for submitting an answer to a question. In accordance with an embodiment, all answer submissions, whether through a cell phone or other device, including the submitting website of the CPR system, is enclosed in asterisks. Once the question is read by the participant and an answer is entered, along with the assigned e-mail address, the “submit answer” button may be pressed to formally submit the answer to the current question (see FIG. 7B).

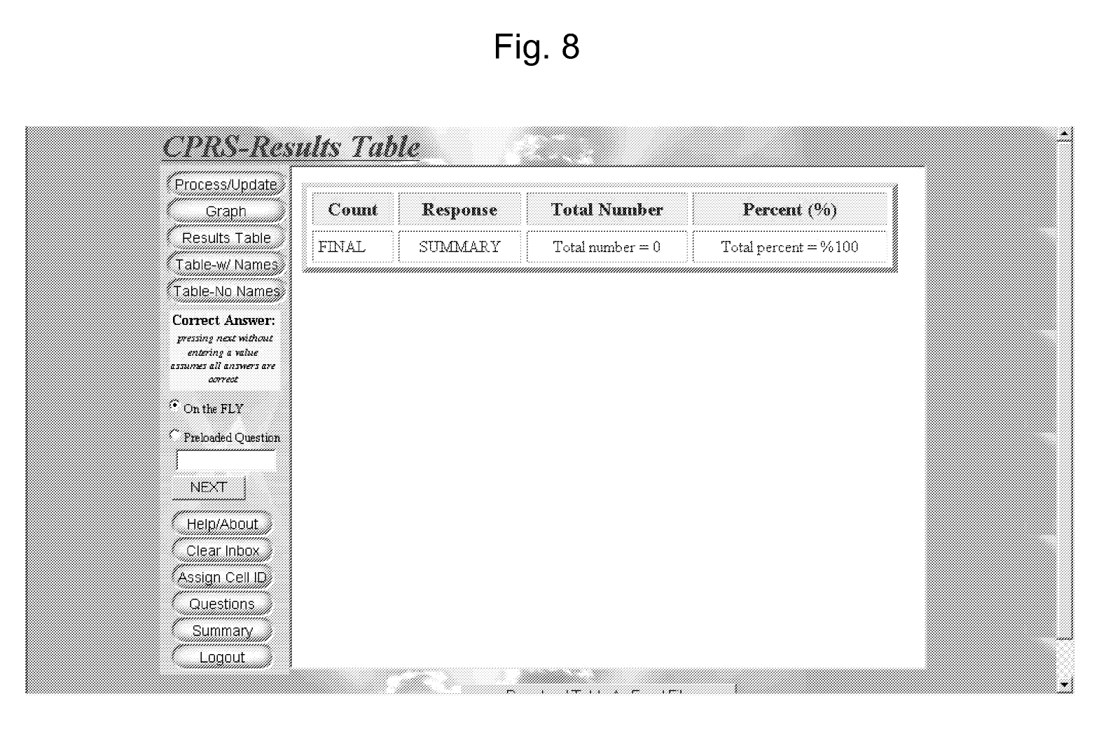

Once participants have submitted their responses to the questions via cell phone or some other device to the specified e-mail address in the correct format as discussed herein, class or group responses may be processed by the system via the user clicking on the “Process/Update” button until all participant responses have been obtained and processed. FIG. 8 illustrates an exemplary embodiment of a screen shot of a results table of the CPR system obtained by clicking on the “Results/Table” button. To obtain how many responses have been processed, the user simply notes the “TOTAL” at the bottom of the Results Table page (see FIG. 8) or the Graph page (see FIG. 3), for example.

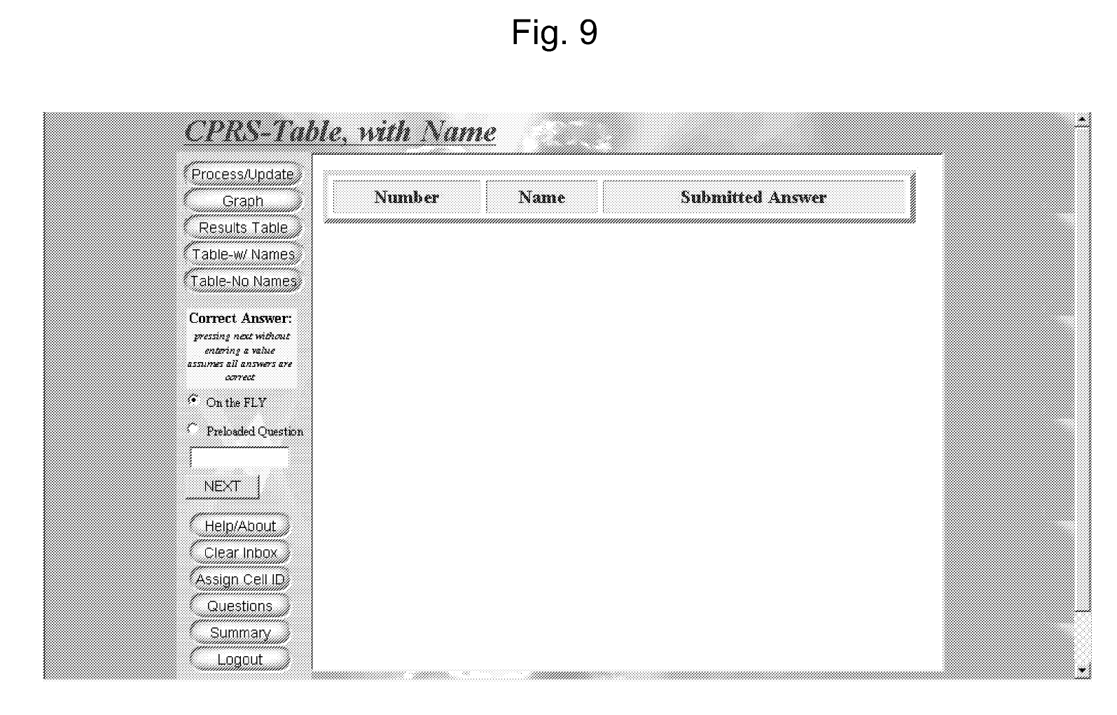

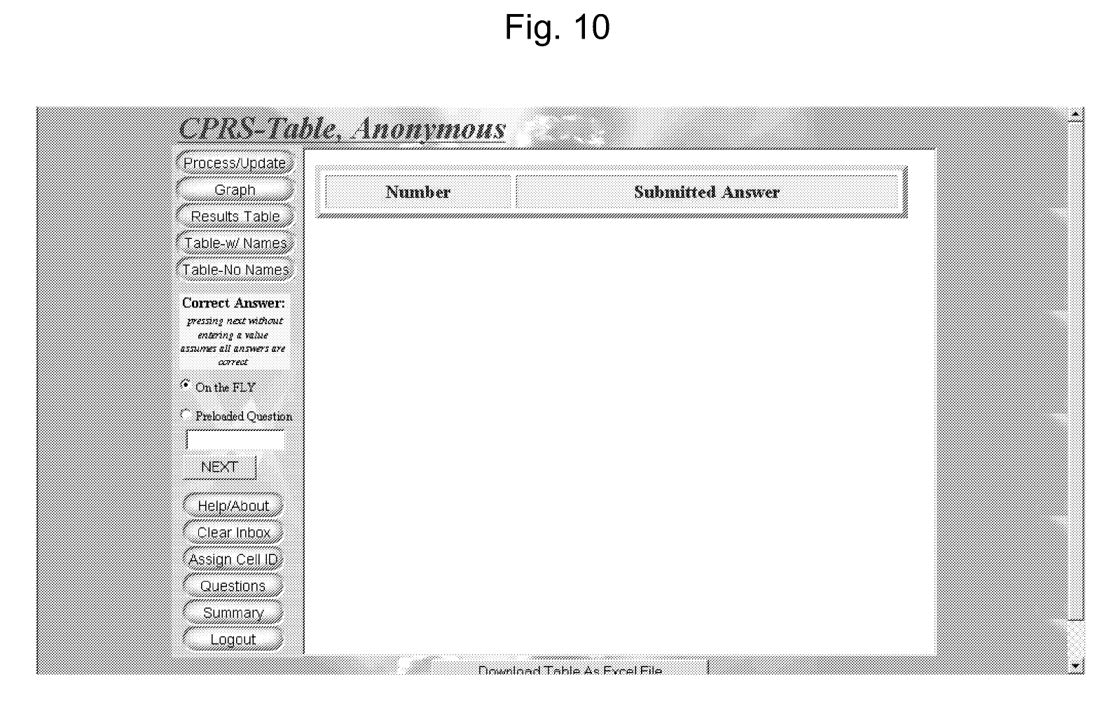

The user may select the various presentation formats to show the participants (e.g., a classroom of students) the responses. The “Graph” and “Results Table” formats show group responses in terms of numbers and percentages. FIG. 9 illustrates an exemplary embodiment of a screen shot of a individual response table of the CPR system with participant names included. FIG. 10 illustrates an exemplary embodiment of a screen shot of a individual response table of the CPR system without participant names included. The “Table with Names” format (see FIG. 9) and “Table No Names” format (see FIG. 10) present individual responses with participant names included or anonymously, respectively. The user may switch between different presentation screens at any time by selecting the button of the corresponding presentation format (e.g., Graph, Results Table, Table-w/Names, Table-No Names).

Once a participant is ready to move onto a next question, the participant may simply enter the answer to the current question in the box provided and then select “NEXT” (see FIG. 8). If the “NEXT” button is selected without entering any value, the program may assume that all answers submitted by the participant are correct and may assign points to all individuals.

Once the “NEXT” button has been selected, the program is ready to process the responses to the next question. If the next question is from the preloaded questions, the participant selects the “preloaded” radio button prior to selecting “NEXT”. This automatically takes the participant to the question page. The user may then select the “Process/Update” button to process the responses for the next question.

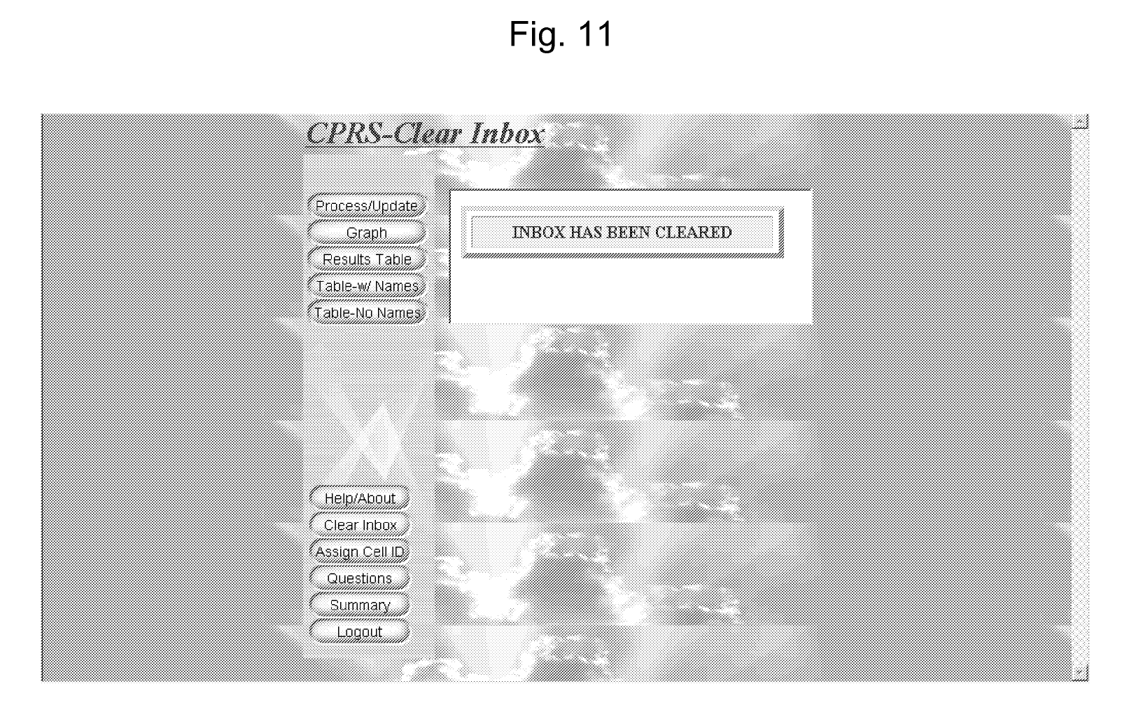

FIG. 11 illustrates an exemplary embodiment of a screen shot associated with clearing submitted participant responses for a particular question. If, for example, the user determines that the present question should be restated even though the participants have already submitted their responses, and the “Process/Update” button has not yet been selected, then the user may select the “Clear Inbox” button to delete the submitted responses (see FIG. 11) and proceed to generate a restated question.

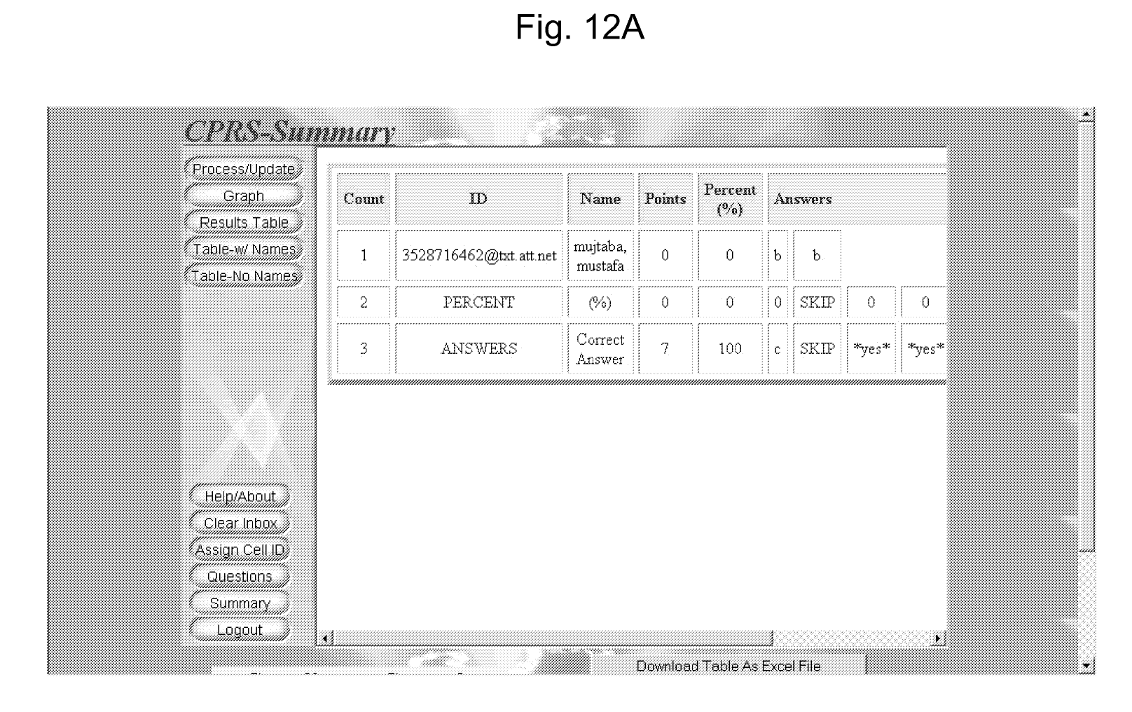

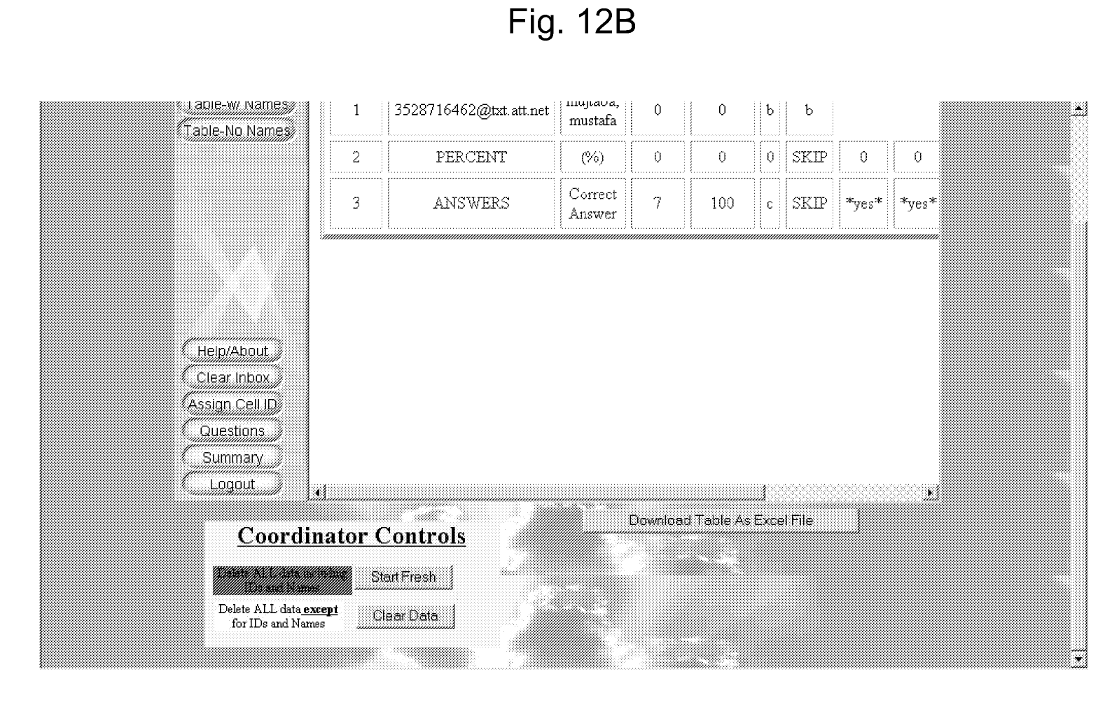

In accordance with an embodiment, responses by each participant may be saved as long as the participant has registered their cell phone ID. FIGS. 12A-12B illustrate an exemplary embodiment of a screen shot associated with a summary of participant results. To view a summary of the results, the user may select the “Summary” button. The summary page (see FIGS. 12A-12B) contains a table showing the percentage of correct answers for each question as a group, and the percentage of correct answers that each participant thus far has provided. The summary page, along with other page results of the CPR system, may be downloaded to a spreadsheet (e.g., Microsoft Excel) or a word processor (e.g., Microsoft Word) for further evaluation. The user may select the “download” button to perform such a download to the user's computer (see FIGS. 12A-12B). The data may also be processed to show it in a desired format, such as by alphabetization of participants for example.

Referring to FIG. 12B, the CPR system provides coordinator controls which allow a user to perform coordinator editing of the results. For example, the user may clear specific data rows or columns (e.g., delete all data except for IDs and names) or the user may start fresh (e.g., delete all data including IDs and Names).

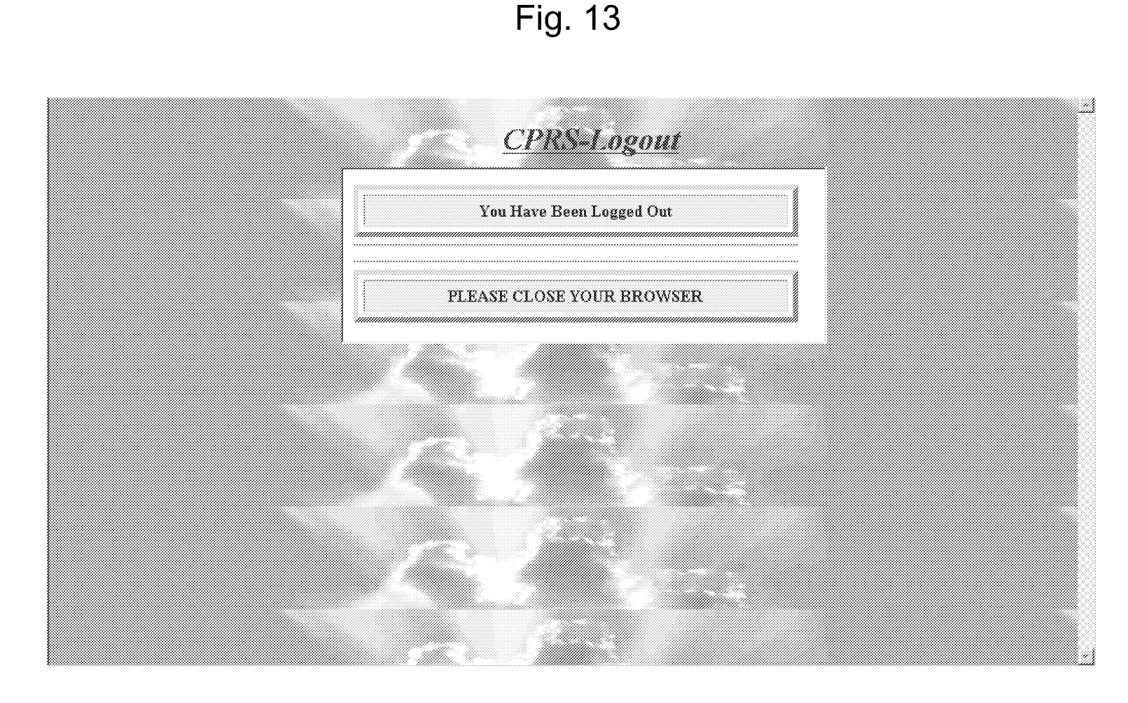

Finally, a user may log out of the CPR system by selecting the “Logout” button. FIG. 13 illustrates an exemplary embodiment of a screen shot associated with logging out of the CPR system.

In the example described, the cell phone response system is an interactive web-based software based system that allows participants in the classroom, lecture hall, meetings, and conferences to interact with the teacher, instructor, presenter, etc. Participants use their cell phones to text message to a specific e-mail address the responses to questions presented by the lead instructor. Based on response evaluations, the instructor can gear the lecture for enhancing student (participant) understanding of the concepts being reviewed. Response is not restricted to cell phones, and the participant may utilize other devices, which can send email, for submitting their responses, including lap top and desktop computers, web enabled PDA's, cell phones, smart phones, etc. The web-based program also contains a website where participants may submit their responses. This web-based system may also be used for conducting surveys or other functions. In addition to the above, the system may be utilized for online classes and meetings. In such cases where the participants are at different locations geographically around the world, but are meeting at the same time, each participant may still view group results via the web. Questions during live session can be asked “on the fly” and responses processed. However, the presenter has the option of uploading the questions to the program prior to the start of their presentation. The system may be configured to automatically advance through the questions each time the presenter “clicks” to go to the next question. All responses may be tabulated and graphed or otherwise displayed. The presenter has several options in terms of presenting the evaluated response results. The program may contain both graphic and tabular formats for result presentation. There are several table forms that may be provided to choose from to present the evaluated responses. The presenter has the option of presenting the group responses anonymously as well. Furthermore, all responses and percent scores from participants that register their cell phone ID may be summarized and saved for later evaluation. Group percent scores may be summarized and saved. All data can be exported (downloaded) to spreadsheet programs or the like, such as MS Excel, for detailed evaluations.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. An interactive web-based polling and response system to facilitate participant/user interaction, said system comprising:
means for providing questions to a group of participants in real time;
means for gathering responses to said questions from said group of participants in real time; and
means for processing and analyzing said responses in real time and presenting results of said analyzing to a user in real time.

2. The system of claim 1, wherein questions are provided during a live session on the fly and responses processed upon receipt.

3. The system of claim 1, wherein questions are uploaded to the system prior to start of interaction and the system automatically advances through the questions upon selection by the user.

4. The system of claim 1, wherein a user is directed to assign an identifier (ID) to each participant to save results of submitted responses.

5. The system of claim 1, wherein the participant devices are web-enabled devices selected from a group consisting of cell phones, PDA's, laptops, computers and smart phones.

6. The system as in claim 1, wherein the means for providing questions to a group of participants in real time is a web site on a global information system, and the means for gathering responses to said questions from said group of participants in real time is receiving email from the participants at the website.

7. The system as in claim 1, wherein the participants are at different locations geographically and each participant may view group results via the website.

8. The system as in claim 1, wherein the system provides coordinator controls which allow a user to perform coordinator editing of the results.

9. The system as in claim 1, wherein the participant uses their cell phone to text message a response to a question to a specific e-mail address assigned to the session.

10. The system as in claim 1, wherein the participant devices comprise an e-commerce application.

11. The system as in claim 1, wherein the presentation of results is made anonymously or in association with a unique ID associated with each participant.

12. The system as in claim 1, wherein results are downloaded to a spreadsheet or word processor.

13. The system of claim 1, wherein upon the user determining that a present question should be restated, and before processing of any responses from the participants, the user may select to delete any submitted responses and proceed to generate a restated question.

14. An interactive web-based polling and response system to facilitate participant/user interaction, said system comprising a website for providing questions to a group of participants in real time, the group of participants using communication devices selected from a group consisting of cell phones, PDAs, smart phones and computers, the participant devices communicating to a website, a processor associated with the website for gathering and analyzing responses to said questions from said group of participants in real time, and presenting results of said processor analyzing to a user in real time.

15. A method to facilitate participant/user interaction, said method comprising:
providing questions to a group of participants in real time;
gathering responses to said questions from said group of participants in real time via a web site on a global information system, wherein gathering responses to said questions from said group of participants in real time is performed by receiving email from the participants at the website; and
analyzing said responses in real time and presenting results of said analyzing to a user in real time.
